(19) United States
(12) Patent Application Publication
(10) Pub. No.: US 2025/0262985 A1
(43) Pub. Date: Aug. 21, 2025

(54) THERMAL REGULATION SYSTEMS AND METHODS OF USING THE SAME

(71) Applicant: Daimler Truck North America LLC, Portland, OR (US)

(72) Inventor: Daniel Bullmore, Battle Ground, WA (US)

(73) Assignee: Daimler Truck North America LLC, Portland, OR (US)

(21) Appl. No.: 19/057,744

(22) Filed: Feb. 19, 2025

Related U.S. Application Data
(60) Provisional application No. 63/556,159, filed on Feb. 21, 2024.

(51) Int. Cl. B60L 58/26; H01M 10/613; H01M 10/625; H01M 10/63

(52) U.S. Cl. CPC B60L 58/26; H01M 10/613; H01M 10/625; H01M 10/63

(57) ABSTRACT

Thermal regulation systems, apparatus, and methods for regulating the temperature of a battery and/or other components of an electrically-powered system. The thermal control system can include a passive valve in communication with to two or more fluid pathways, a first pump, and a second pump. In some examples, a position of a shuttle within a housing of the passive valve can be controlled based on a ratio of a first pressure generated by the first pump to a second pressure generated by the second pump. In some examples, a position of a shuttle within a housing of the passive valve can be controlled based activating one of the first pump or the second pump while the other pump is inactive.

### CROSS-REFERENCE TO RELATED APPLICATIONS

This application claims the benefit of U.S. Provisional Patent Application No. 63/556,159, filed Feb. 21, 2024, which is incorporated by reference herein in its entirety.

### FIELD

This disclosure generally relates thermal regulation systems and methods of using the same.

### BACKGROUND

Thermal regulation systems can be used in various environments, including, for example, in environments that utilize battery and/or fuel cell sources.

For example, electric vehicles (EVs) can include a battery for providing power to the vehicle for propulsion and for powering various electrical components of the vehicle. A large amount of heat may be generated by the battery and overheating can be a major cause of EV battery degradation. A thermal regulation system can be utilized to regulate the temperature of the battery and other components of the electrically powered system to protect such components from heat damage. Additionally, the battery and/or other components of the electric power system may function optimally within a specified temperature range. The thermal regulation system can be used to maintain the battery and/or other components at desired a operating temperature or within a specified temperature range (for example, at a temperature between 60-80° F.), which can, for example, improve discharge power availability, improve charge acceptance during regenerative braking, and/or improve lifetime of the battery.

Some EVs can further include a fuel cell (such as, for example, a hydrogen fuel cell) for generating electricity onboard the vehicle. Similar to a battery, the fuel cell can produce a large amount of heat during its operation and the thermal regulation system can be utilized to remove excess heat and prevent damage to the fuel cell. Further, the hydrogen fuel cell may function optimally within a specified temperature range, and the thermal regulation system can be used to maintain the fuel cell at a desired operating temperature or within a specified temperature range (for example, at a temperature between 60-80° F.).

In some examples, the thermal regulation system can include a liquid-based cooling/heating mechanism configured for flow of fluid (for example, water and ethylene glycol) through various pathways (which can also be referred to as “cooling loops” or “cooling circuits”) in the electric power system, which enables heat exchange and cooling of the components when above a desired temperature and warming of the components when below a desired temperature. Conventional thermal control systems include electrically actuatable valves for controlling flow of fluid through the various circuits in the system, for example, by selectively opening one or more valves to enable flow of fluid through a pathway and selectively closing one or more valves to disable flow of fluid through another pathway. Conventional thermal control systems used in environments that require thermal regulation, however, suffer from various deficiencies and improvements to such systems are desirable.

### SUMMARY

Described herein are thermal regulation systems and methods of using the same. In some examples, the systems and methods include one or more passively controlled valves for controlling flow of fluid through various pathways (e.g., coolant loops or circuits) for regulating the temperature of a battery and/or other components of an electric power system. The thermal control system can include a passive valve coupled to two or more fluid pathways, a first pump, and a second pump. In some examples, the flow of fluid through selected ones of the fluid pathways (to e.g., activate one or more selected coolant loops) is directed and/or controlled by a position of a shuttle within the passive valve. In some examples, the position of the shuttle within the passive valve can be controlled based on a ratio of a first pressure generated by the first pump to a second pressure generated by the second pump. In some examples, a position of a shuttle within the passive valve can be controlled based activating one of the first pump or the second pump while the other pump is inactive.

In some examples, the thermal regulation system is a component of an electric power system.

In some examples, the thermal regulation system is a component of an electric vehicle (EV), such as, for example, a battery-powered electric vehicle (BEV), a fuel cell-powered electric vehicle (FCEV), or a hybrid electric vehicle (HEV).

In some examples, the thermal regulation system is a component of a refrigeration system.

In some examples, the thermal regulation system is a component of a computer server system.

In some examples, the thermal regulation system includes: a passive valve comprising a shuttle disposed within a housing; a first pump in fluid communication with the passive valve, a second pump in fluid communication with the passive valve, a first fluid pathway in fluid communication with a first opening in the passive valve, and a second fluid pathway in fluid communication with a second opening in the passive valve.

In some examples, a position of the shuttle is controllable via controlling operation of each of the first and second pumps.

In some examples, the shuttle is configured to direct flow of fluid from one or more of the first pump or the second pump through the passive valve to one or more of the first fluid pathway or the second fluid pathway based at least on the position of the shuttle within the housing.

In some examples, a battery-powered electric vehicle includes: an electric drive unit coupled to one or more wheels of the vehicle, a battery pack for powering the electric drive unit, and a thermal regulation system for regulating an operating temperature of the electric drive unit and an operating temperature of the battery pack.

In some examples, the thermal regulation system comprises: a fluid pathway network, a first pump fluidly coupled to a first portion of the fluid pathway network upstream of the electric drive unit, a second pump fluidly coupled to a second portion of the fluid pathway network upstream of the battery pack, a first passive valve fluidly coupled to the fluid pathway network downstream of the first and second pumps, a first temperature sensor in communication with the battery pack, and a computerized controller in signal communication with the first temperature sensor and each of the first and second pumps.

In some examples, the computerized controller is configured to, based at least on a first temperature of the battery pack detected by the first temperature sensor, control a position of the shuttle to direct coolant through the fluid pathway network over one or more selected coolant loops via controlling operation of the first and second pumps.

In some examples, the passive valve is a first passive valve.

In some examples, the thermal regulation system comprises a second passive valve for closing a battery coolant loop during operation of the second pump.

In some examples, a method of operating a thermal regulation system includes determining a selected one of a plurality of operational states for the electrical system based at least on temperature data for one or more components of the electrical system.

In some examples, the method further includes controlling operation of a first pump and a second pump to control a position of a shuttle within a passive valve for directing flow of coolant within a fluid pathway network of the thermal regulation, wherein the first pump is fluidly coupled to a first portion of the fluid pathway network upstream of the passive valve and the second pump is fluidly coupled to a second portion of the fluid pathway network upstream of the passive valve, wherein a third portion of the fluid pathway network is downstream of the passive valve and in fluid communication with a first outlet of the passive valve.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic illustration of a thermal control system for an electric power system, in accordance with the present disclosure.

FIG. 2 is a schematic illustration of an exemplary passive valve that can be included in the thermal control system of FIG. 1.

FIG. 3 is a schematic illustration of the thermal control system of FIG. 1 showing a “mixed mode” function of the thermal control system.

FIG. 4 is a schematic illustration of the thermal control system of FIG. 1 showing a “split mode” function of the thermal control system.

FIG. 5 is a schematic illustration of the thermal control system of FIG. 1 showing a “precondition heating mode” function of the thermal control system.

### DETAILED DESCRIPTION

### Explanation of Terms

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved. The scope of this disclosure includes any features disclosed herein combined with any other features disclosed herein, unless physically impossible.

As used in this disclosure and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In the description, certain terms may be used such as “forward,” “front,” “rear,” “up,” “down,” “upper,” “lower,” “horizontal,” “vertical,” “left,” “right,” “first side,” “second side,” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface by turning the object over. Nevertheless, it is still the same object.

Similar components in different embodiments are described in the specification and illustrated in the figures with similar reference numbers for improved understanding and readability. However, it should be understood that this numbering convention is merely for convenience and is not intended to limit and/or exclude any claim scope.

Although there are alternatives for various components, parameters, operating conditions, etc., set forth herein, that does not mean that those alternatives are necessarily equivalent and/or perform equally well. Nor does it mean that the alternatives are listed in a preferred order unless stated otherwise.

### Overview

As discussed above, conventional thermal regulation systems include electrically actuatable valves for controlling flow of fluid through pathways (e.g., coolant loops or circuits) that extend through and/or around components of an electric power system. However, thermal regulation systems including such valves have numerous issues and disadvantages. For example, electrically actuatable valves increase cost and complexity of the thermal regulation system. In another example, electrically actuatable valves can be fragile and may break and/or require frequent repair. In yet another example, such thermal regulation systems require development and maintenance of specialized software for controlling coordinated opening and closing of the valves during operation of an electric power system in order to control and/or change an operational mode of the system and redirect flow of coolant.

The systems, apparatus, and methods disclosed herein address one or more of the foregoing issues. For example, the thermal regulation systems disclosed herein can include one or more passive valves (for example, one or more check valves). A passive valve can be fluidly coupled within a thermal control system between two or more fluid pathways. A position of a shuttle within a passive valve (for e.g., opening and/or closing access to certain ones of the fluid pathways) can be controlled by a first pump and a second pump that are each in communication with the passive valve. In some examples, a position of a shuttle within a passive valve can be controlled based on a ratio of a first pressure generated by the first pump to a second pressure generated by the second pump. In some examples, a position of a shuttle within a passive valve can be controlled by activating one of the first pump or the second pump while the other pump is inactive.

Thus, the thermal regulation systems disclosed herein can exclude electrically actuatable valves or can require fewer electrically actuatable valves than a conventional thermal regulation system, thereby reducing cost of the system, reducing the need for maintenance and repair of the electrically actuatable valves, and/or reducing the need for on-board programming to control opening and closing of electrically actuatable valves.

Although the exemplary thermal control systems are described herein as a component of a battery-powered electric vehicle (BEV), it will be appreciated that the thermal control systems can be utilized in other types of electric power systems. For example, the exemplary thermal control systems can be utilized in a fuel cell-powered electric vehicle (FCEV), a hybrid electric vehicle (HEV), a refrigeration system, a computer server system, and/or other battery-powered or fuel cell-powered systems.

### Examples of the Disclosed Technology

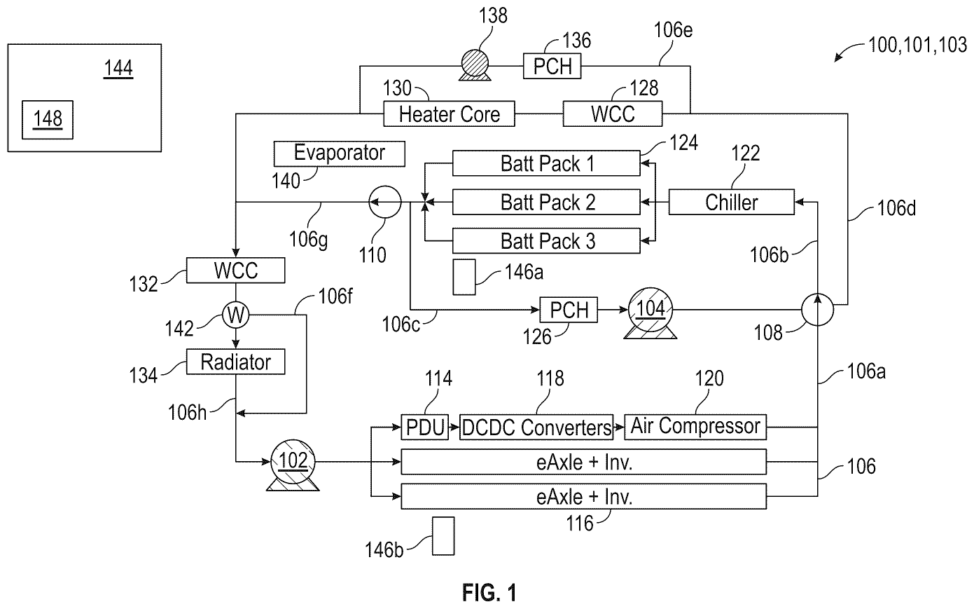

FIG. 1 illustrates an electric power and thermal regulation system 100 for a BEV. In some examples, the system 100 can include a power subsystem 101, which can include a power distribution unit (PDU) 114, two drive units 116, DC/DC converters 118, an air compressor 120, and a battery 124. The drive units 116 can be, for example, two electric axles (eAxles). Each eAxle can include a motor, gearing, and/or other power electronics and can be positioned between driven wheels of the BEV for controlling propulsion and deceleration of the BEV, as well as for recovering energy through regenerative braking. In some examples, the power subsystem 101 can include a single drive unit 116 (for example, a single eAxle). In some examples, the drive unit 116 can be other types of drive units, for example, an electric engine coupled to a transmission.

The PDU 114 can be configured to control power distribution to the drive units 116 and/or other electrical components of the BEV. In some examples, the PDU 114 can be an intelligent and/or networked PDU (iPDU) in communication with a computerized controller of the vehicle (such as, for example, the computerized controller 144, discussed below, or another controller of the BEV), which is configured to enable monitoring of operational parameters and/or conditions of the BEV, communication of diagnostic information, and/or power control or management. In some examples, the DC/DC converters 118 can be configured to convert higher-voltage power from the vehicle's battery (i.e., the battery pack 124 discussed below) to smaller, more usable voltages needed to run, for example, vehicle accessories (e.g., interior lights, head lights, etc.). In some examples, the air compressor 120 is an electric air compressor that is configured for powering the vehicle's brake system.

In some examples, the battery 124 (which can also be referred to as a “traction battery” or a “battery pack”) can include a plurality of battery cell arrays (for example, three battery cell arrays, as illustrated in FIG. 1, or more or fewer battery cell arrays) each including one or more battery cells. The battery cells can be, for example, prismatic, pouch, cylindrical, or other types of cells for converting stored chemical energy to electrical energy. The cells can each include a housing, a positive electrode (cathode), and a negative electrode (anode). An electrolyte can allow ions to move between the anode and cathode during discharge, and then return during recharge. Terminals on the cells can allow current to flow to and from the respective cell.

In some examples, the battery pack 124 can be a lithium-ion battery (such as, for example, a lithium-iron-phosphate (LFP) battery, a nickel, manganese, and cobalt (NMC) battery, or a nickel, manganese, cobalt, and aluminum (NMCA) battery). The battery pack 124 can store energy that can be used by electrical components of the BEV, such as, for example, the drive units 116. In some examples, the battery pack 124 can provide a high-voltage direct current (DC) output from one or more of the battery cell arrays.

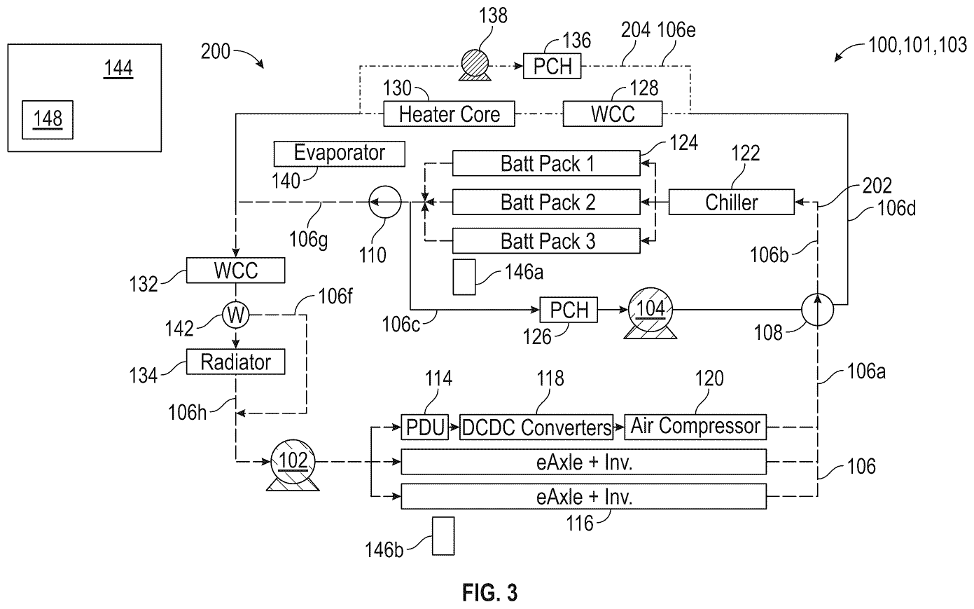

As discussed above, the battery pack 124 and other electrical components of the BEV (such as, for example, the PDU 114, the drive units 116, the DC/DC converters 118, the air compressor 120, and/or other electrical components of the BEV) can be thermally regulated to, for example, maintain a desired and/or optimal operating temperature. Accordingly, the system 100 can further include a thermal regulation subsystem 103 (also referred to herein as a “thermal regulation system”), which can include a first pump 102 and a second pump 104 coupled to a network of fluid pathways 106 (also referred to herein as a “fluid pathway network”) for directing coolant through the system 100. In some examples, the thermal regulation subsystem 103 can further include a (first) passive valve 108 and a (second) passive valve 110 coupled to the fluid pathway network 106, which are each configured to open and/or close to define and/or direct flow of coolant through selected fluid pathways within the fluid pathway network 106 (which can also be referred to as “coolant loops” and “coolant circuits”) for operating the system 100 in various operational modes. Exemplary operation modes for the system 100 are discussed further below with reference to FIGS. 3-5.

In some examples, the thermal regulation subsystem 103 can further include a chiller 122 upstream of the battery pack 124, an electrically powered coolant heater (PCH) 126 upstream of the second pump 104, a water-cooled condenser (WCC) 128 upstream of a heater core 130, a PCH 136 and a coolant heater pump 138, a WCC 132 upstream of a radiator 134, and an evaporator 140.

In some examples, the chiller 122 can be a powered refrigerant component of the thermal regulation subsystem 103. For example, the chiller 122 can be compact plate-to-plate heat exchanger comprising a plurality of pressed and/or sealed plates forming parallel flow channels and having troughs that interlink between the plates to allow flow of fluid therethrough. Flow of fluid through the chiller 122 can enable transfer thermal energy between the fluid and the plates for cooling of the fluid.

In some examples, the PCHs 126, 136 are heating units configured to warm fluid (e.g., coolant) flowing therethrough. For example, either or both of the PCHs 126, 136 can be a forced flow heater, a positive temperature coefficient (PTC) coolant heater, or other types of coolant heaters.

In some examples, the WCCs 128, 132 are heat exchangers that comprise a network of water coils that are configured to transfer heat from a network of condenser coils having vapor flowing therethrough. As heat is transferred from the condenser coils, the vapor is condensed into a liquid. In some examples, either or both of the WCCs 128, 132 can be a plate-type heat exchanger (similar to, e.g., the chiller 122 discussed above), a shell and coil WCC, a double tube WCC, a shell and tube WCC, or other types of water-cooled condensers.

In some examples, the heater core 130 is configured for heating the cabin of the BEV. Hot coolant (which can be, for example, hot coolant heated by upstream BEV components, such as the eAxles 116, or coolant heated by the PCH 136 and circulated by the pump 138) can be passed through a winding tube of the core, which acts as a heat exchanger between coolant and cabin air. Fins attached to the core can enable heat transfer to air that is forced over the fins by a fan, thereby heating the BEV cabin. Because the heater core can cool the heated coolant by transferring its heat to the cabin air, it can also act as an auxiliary radiator in the thermal regulation system 103.

In some examples, the evaporator 140 is configured for cooling the cabin of the BEV. In some examples, a refrigerant gas can be compressed by a refrigerant compressor (not shown) and condensed into a liquid in WCCs 128 and/or 132. This liquid can flow into a coil of the evaporator 140, where it evaporates and absorbs heat from the air. The gaseous refrigerant may then return to the compressor and the cooled air can then be pumped into the cabin by a fan.

In some examples, the radiator 134 is configured for cooling of fluid passing through a series of radiator tubes. In some examples, as the coolant passes through the radiator tubes, heat is transferred to the tubes which in turn transfer heat to fins disposed between each of the tubes, and the fins then release the heat to the ambient air.

In some examples, the thermal regulation subsystem 103 can further include temperature sensors that are configured to monitor an operating temperature of respective ones of the BEV components and communicate temperature signals to a computerized controller of the BEV. For example, one or more first temperature sensors 146a can be coupled to the battery pack 124 and one or more second temperatures sensors 146b can be coupled to the drive units 116. In some examples, the first and second temperature sensors 146a, 146b can be in communication with the computerized controller 144.

In some examples, the computerized controller 144 may be one or more controllers configured to control and/or monitor the operation of the system 100 of the BEV. In some examples, the controller 144 may communicate (via e.g., a communication interface) with other BEV systems and controllers over one or more wired or wireless vehicle connections using common bus protocols (e.g., CAN and LIN). In some examples, the controller 144 may communicate via a serial bus (e.g., Controller Area Network (CAN)) or via dedicated electrical conduits. The controller 144 can include any number of microprocessors, ASICs, ICs, a memory 148 (e.g., FLASH, ROM, RAM, EPROM and/or EEPROM) and software code (e.g., computer-readable instructions) to co-act with one another to perform a series of operations stored in the memory 148. The controller 144 can also include predetermined data, such as, for example, “look up tables” that are based on calculations, model data, and/or test data, stored in the memory 148.

In some examples, the controller 144 can receive temperature data and/or signals from the temperature sensors 146a, 146b. In some examples, the controller can process the temperature readings to determine whether temperature conditions of the BEV components (such as, for example, the battery 124 and/or the drive units 116) are within a desired or selected operating temperature range. In some examples, the controller 144 can control operation of the thermal regulation system 103 based at least on the temperature data. In some examples, the controller 144 can be in signal communication with each of the first pump 102 and the second pump 104 to control an operational state and/or a fluid pressure produced by each pump. In some examples, control of the operation of and/or fluid pressure generated by each of the first and second pumps 102, 104 enables control of opening and closing of one or more of the passive valves 108, 110 for activating and/or deactivating selected coolant loops within the fluid pathway network 106. In some examples, control of the operation and/or fluid pressure of each of the first and second pumps 102, 104 enables control of an operational mode of the system 100.

In some examples, the first pump 102 is an electric drive (eDrive) pump. In some examples, the second pump 104 is a battery pump. Each of the first pump 102 and the second pump 104 can be configured to deliver and/or circulate coolant to components downstream of the respective pump in an open and/or activated coolant loop (which can also be referred to as a “coolant circuit”).

In some examples, the pump 102 can be located in a fluid pathway 106a upstream of the PDU 114, the drive units 116, the DC/DC converters 118, and the air compressor 120. In some examples, the chiller 122 and the battery pack 124 can be in a fluid pathway 106b and the PCH 126 and the second pump 104 can be in a fluid pathway 106c, which are downstream of the DC/DC converters 118 and the air compressor 120. The passive valve 108 can be disposed between the fluid pathways 106a and 106b and a fluid pathway 106d, in which the WCC 128, the heater core 130, the WCC 132 and the radiator 134 are located. In some examples, the PCH 136 and the coolant heater pump 138 can be located in a fluid pathway 106e, which can enable circulation of fluid to the WCC 128 and the heater core 130 in the fluid pathway 106d.

In some examples, the passive valve 110 can be coupled between a fluid pathway 106g and the fluid pathways 106b, 106c. The fluid pathway 106g connects to the fluid pathway 106d at a location that is upstream of the WCC 132 and downstream of the heater core 130. In some examples, a passive thermal control device 142, such as a wax thermostat or another type of passive thermal control device, is coupled between the fluid pathway 106d and fluid pathway 106f, which bypasses the radiator 134. The radiator 134 is in a fluid pathway 106h.

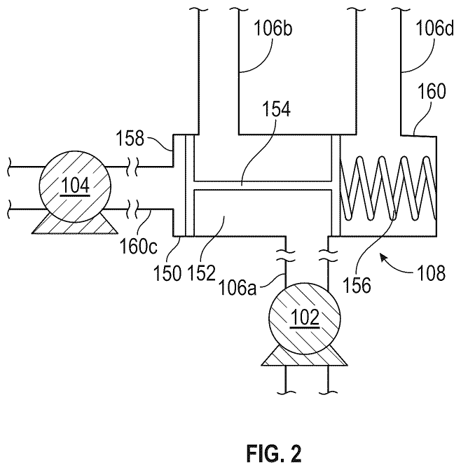

As discussed above, flow of fluid through selected ones of the fluid pathways can be controlled by opening and/or closing of the first and second passive valves 108, 110. A position of a shuttle (or other check device) within the valves 108, 110 can be controlled via operation of one or more of the pumps 102, 104. For example, FIG. 2 includes a schematic illustration of the passive valve 108. As can be seen therein, in some examples, the passive valve 108 includes a housing or valve body 150 having a bore 152 disposed therein that is in fluid communication with each of the fluid pathways 106a, 106b, 106c, 106d. A shuttle 154 (which can also be referred to as a “stopper” or a “multi-positional stopper”) is disposed within the bore 152 and is coupled to a biasing structure 156 (e.g., a spring, a compressible member, etc.). In some examples, the biasing structure 156 biases the shuttle 154 toward a first end portion 158 of the valve body 150 (which can be an end portion that is in communication with the fluid pathway 106c) and away from a second, opposing end portion 160 of the valve body 150.

The shuttle 154 is moveable within the housing 150. A position of the shuttle 154 within the bore 152 can be controllable via controlling operation of each of the first and second pumps 102 and 104, and/or by controlling a ratio of a first pressure produced by the first pump to a second pressure produced by the second pump. In some examples, the computerized controller 144 can determine and/or select an operational mode for the BEV based on temperature signals or data received from one or more of the temperature sensors 146a, 146b (and/or other temperature sensors). In some examples, the operational mode can be selected in order to maintain a desired operating temperature for one or more components of the system 100 of the BEV, such as, for example, the battery pack 124 and/or the electric drive units 116.

In some examples, when the system 100 is operated such that the first pump 102 is producing pressure and the second pump 104 is inactive (i.e., is not producing pressure), flow of fluid from the first pump 102 (along the fluid pathway 106a) is directed through the valve bore 152 to fluid pathway 106b, while the biasing structure 156 holds the shuttle 154 in such a position as to prevent flow to the fluid pathway 106d.

In some examples, when the system 100 is operated such that the second pump 104 is producing pressure and the first pump 102 is inactive (i.e., is not producing pressure), the shuttle 154 is hydraulically displaced (unseated) so as to compress the biasing structure 156 and uncover a port (i.e., inlet) to the fluid pathway 106b, thereby directing flow of fluid from the second pump 104 (along the fluid pathway 106c) to the fluid pathway 106b.

In some examples, when the system 100 is operated such that pressures generated by the first pump 102 and the second pump 104 are at a specified ratio (for example, where the first pump 102 produces less pressure than the second pump 104), the shuttle 154 can be partially unseated (e.g., moved such that the distal wall of the shuttle 154 is aligned with or bisects the outlet to the fluid pathway 106b) to direct flow of fluid from the first pump 102 (along the pathway 106a) and flow of fluid from the second pump 104 (along the pathway 106c) to the fluid pathway 106b. In some examples, the first and second pumps 102, 104 can be operated to produce a balance of pressures between the first and second pumps that result in the shuttle 154 being held and/or retained in the partially unseated position. In such examples, the fluid flowing into the fluid pathway 106b can cause a blending of coolant inflows from the pathways 106a, 106c (which can be e.g., a blend of a first portion of coolant having a first temperature from the first pump and a second portion of coolant having a second, different temperature from the second pump).

In some examples, when the system 100 is operated such that the first pump 102 produces no pressure or a lesser pressure than the second pump 104, and/or if a ratio a first pressure generated by the first pump relative to a second pressure generated by the second pump is less than a threshold, the shuttle 154 can be fully unseated (e.g., moved such that the distal end of the shuttle 154 is proximal relative to the outlet to the fluid pathway 106b) (which can be referred to as a “fully unseated state,” a “fully displaced state,” or “full displacement”) to direct fluid flowing from the second pump 104 along the fluid pathway 106c to the fluid pathway 106b, while directing flow of fluid from the first pump 102 along the fluid pathway 106a to the fluid pathway 106d.

It will be appreciated that, in some examples, the passive valve 110 can have a similar structure to the valve 108 shown in FIG. 2. In some examples, the passive valve 110 can have a different structure and can be, for example, a ball check valve, a diaphragm check valve, a swing check valve, or other check valve. In some examples, the passive valve 110 can be biased toward an open state and operation of the second pump 102 can apply suction to close to the passive valve 110. In some examples, the passive valve 110 can be biased toward a closed state and fluid pressure above a threshold applied to a check device within the valve can open the valve 110.

The foregoing control of the first and second pumps 102, 104 to direct flow of fluid through the passive valve 108 and selected ones of the fluid pathways can be utilized for operating the system 100 in various operational modes by allowing, enabling, directing, and/or causing flow of fluid through selected coolant loops or circuits within the fluid pathway network 106. For example, FIGS. 3-5 show exemplary operational modes 200, 210, 220 for the system 100 that can be implemented by controlling operation of the first and second pumps 102, 104.

In some examples, the operational modes 200, 210, 220 can be implemented without the use of electrically actuatable valves. In some examples, the operational modes 200, 210, 220 can be implemented via controlling each of the first and second pumps 102, 104 in combination with controlling one or more electrically actuatable valves included in the system 100. For example, in some examples, the passive valve 110 can be replaced with an electrically actuatable valve.

Turning to FIG. 3, a first operational mode 200 for the system 100 is illustrated. In some examples, the first operational mode 200 can be a primary operational mode for the system 100. In some examples, the first operational mode 200 can also be referred to as a “mixed mode” operational state. In this example, the first pump 102 can be operated to circulate coolant and generate a fluid pressure, while the second pump 104 is inactive. As discussed above, under such conditions, the passive valve 108 can have its plunger in its resting state position and enable and/or direct flow of fluid from the first pump 102 along the pathway 106a to the pathway 106b.

As can be seen in FIG. 3, in the first operational mode 200, coolant can be circulated by the first pump 102 through the fluid pathways 106a, 106b, 106g, 106f, which can be referred to as a full vehicle loop 202 (illustrated in even dashed lines in FIG. 3). In some examples, the first pump 102 can cause circulation of coolant through the full vehicle loop 202 in the operational mode 200.

In some examples, when operated in the mixed mode 200, if the battery pack 124 is cooler than the coolant, heat can be transferred to the battery 124. If the battery pack 124 is warmer than the coolant, heat can be transferred from the battery 124 to the coolant. In some examples, the coolant can be chilled prior to entering the battery pack 124 via the chiller 122. In some examples, heat can be reintroduced to the coolant via the WCC 132 after circulation through the battery pack 124. In some examples, if the coolant downstream of the WCC 132 exceeds a threshold temperature (e.g., 70° C.), the wax thermostat 142 can open to enable and/or permit flow of coolant to the radiator 134 (which can also be referred to as a “heat rejection device”) for cooling of the coolant. Alternatively, if the coolant downstream of the WCC 132 is below the threshold temperature, the wax thermostat 142 can remain closed and cause flow of coolant to the pathway 106f to bypass the radiator 134.

In the first operational mode 200, the cabin cooling and/or heating can function independently of the full vehicle loop 202 via a cabin heating and cooling loop 204 (illustrated in uneven broken line in FIG. 3). In some examples, coolant can be circulated through the cabin heating and cooling loop 204 via operation of the pump 138. For example, the cabin can be heated by operation of the PCH 136 and/or the heater core 130, and/or by heat rejected from the WCC 128. The cabin can be cooled by operation of the evaporator 140.

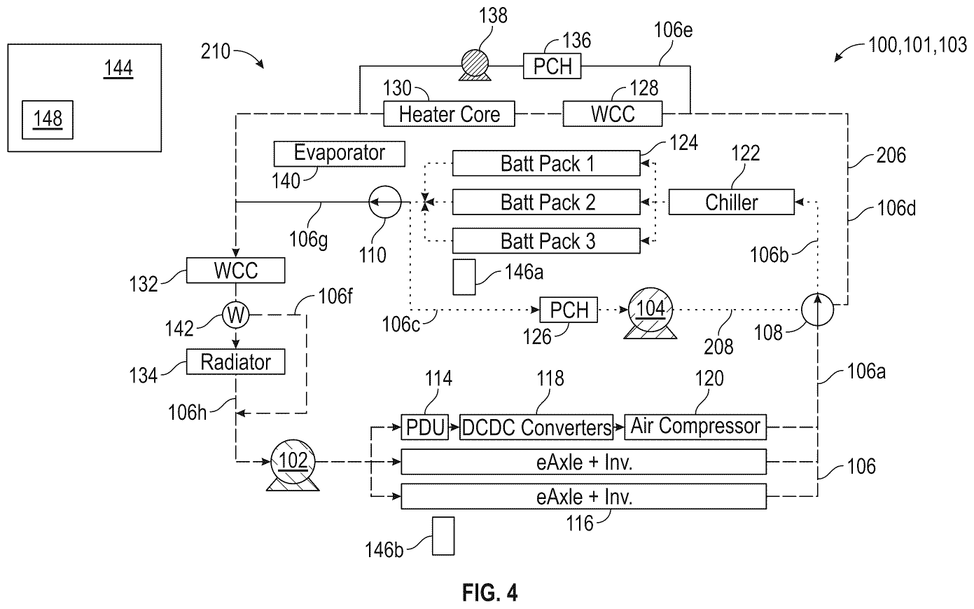

In some examples, in the operational mode 200, pre-cooling of the battery pack 124 may be limited to, for example, WCC heat rejection minus cabin demand. When the limit is exceeded, the system 100 can be transitioned to a second operational mode 210 shown in FIG. 4. In some examples, the second operational mode 210 can also be referred to as a “split mode” operational state and/or a “pre-conditioning cooling mode” operational state. In this example, each of the first and second pumps 102, 104 can be operated to circulate coolant and generate a fluid pressure, wherein a first pressure generated by the first pump 102 is less than a second pressure generated by the second pump 104. As discussed above, under such conditions, the passive valve 108 can have its plunger in a partially unseated state (which can also be referred to as a “partially displaced state” or “partial displacement”) and enable and/or direct flow of fluid from the first pump 102 along the fluid pathway 106a to the fluid pathway 106d and flow of fluid from the second pump 104 along the fluid pathway 106c to the fluid pathway 106b.

As can be seen in FIG. 4, in the second operational mode 210, coolant can be circulated by the first pump 102 through the fluid pathways 106a, 106d, 106f, 106h which can be referred to as an outer loop 206 (shown in even dashed line in FIG. 4). Coolant can be circulated by the second pump 104 through the fluid pathways 106c, 106b, which can be referred to as a battery loop 208 (shown in dotted line in FIG. 4). Differential pressure between the first and second pumps 102, 104 can cause the passive valve 110 to close, which thereby closes and/or completes the battery loop 208. In other words, the battery loop 208 can be closed during operation of the second pump 104.

In some examples, coolant circulated in the outer loop 206 is separate from and does not mix with coolant circulated in the battery loop 208. In some examples, coolant circulated within the battery loop 208 can be chilled by the chiller 122 and heat can be transferred from the battery 124 to the coolant.

In some examples, the first pump 102 can reject heat into the outer loop 206. In some examples, heat removed via the evaporator or chillers can be rejected to the coolant via the WCCs 128, 132. In some examples, if the coolant downstream of the WCC 132 exceeds a threshold temperature (e.g., 70° C.), the wax thermostat 142 can open to enable and/or permit flow of coolant to the radiator 134. Alternatively, if the coolant downstream of the WCC 132 is below the threshold temperature, the wax thermostat 142 can remain closed and cause flow of coolant to the pathway 106f to bypass the radiator 134. In some examples, coolant circulated in the outer loop 206 can be heated by the heater core 130.

In the second operational mode 210, the cabin can be heated by heat generated via the drive units 116, the PCH 136, and/or the WCC 128, which can be transferred to the cabin air via the heater core 130. In some examples, the cabin can be cooled by operation of the evaporator 140.

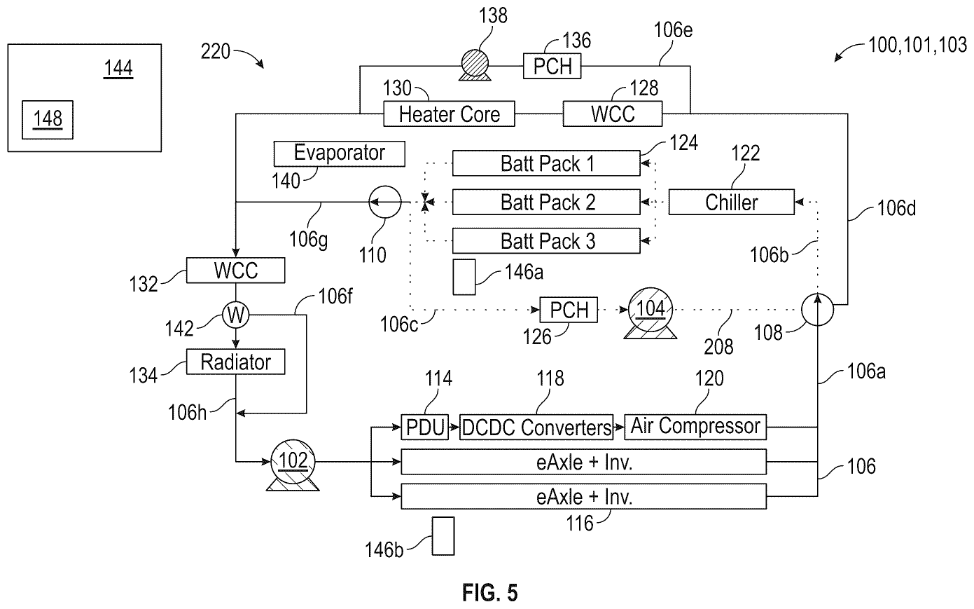

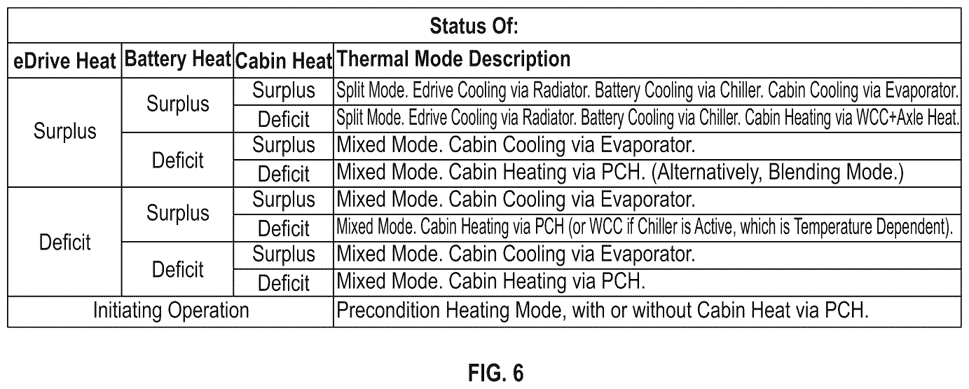

FIG. 5 illustrates a third operational mode 220. In some examples, the third operational mode 220 can also be referred to as a “pre-conditioning heating mode” operational state. In this example, the second pump 104 is operated to circulate coolant and generate a fluid pressure, while the first pump 102 is inactive. As discussed above, under such conditions, the passive valve 108 can have its plunger in an unseated state and can enable and/or direct flow of fluid from the second pump 104 along the fluid pathway 106c to the fluid pathway 106b. As in the mode 210, coolant can be circulated by the second pump 104 through the battery loop 208 (shown in dotted line in FIG. 5), and the passive valve 110 can be closed to complete and/or close the battery loop 208). In some examples, coolant circulated within the battery loop 208 can be warmed by the PCH 126 and heat can be transferred from the coolant to the battery 124.

It will be appreciated that the operational modes 200, 210, 220 are merely exemplary, and other operational modes can be implemented via controlling operation of the first and second pumps 102, 104 and the other components of the subsystem 103 for thermal regulation of the system 100. For example, the system 100 can be operated in a “blending mode” where the first and second pumps are controlled to produce a balance of pressures between the first and second pumps that result in the shuttle being held and/or retained in a partially unseated position, which thereby can cause the passive valve to enable and/or direct flow of fluid the first pump 102 (along the pathway 106a) and flow of fluid from the second pump 104 (along the pathway 106c) to the fluid pathway 106b. As discussed above with reference to FIG. 2, under such operation, fluid flowing from the first pump 102 along the pathway 106a can be mixed with fluid flowing from the first pump 104 along the pathway 106c and a blended fluid can flow to the fluid pathway 106b.

In some examples, the system 100 can be operated in and/or transitioned between operational modes depending on heating and/or cooling requirements of various ones of the components of the electrical system. In some examples, the controller 144 can select an operational mode and/or can cause transition from one operational mode to another based on a heat deficit status or a heat surplus status of one or more components of the system 100. In some examples, the controller 144 can select an operational mode based on based on the system 100 being transitioned from a non-operational state to an operational state (e.g., based on “starting” the electric vehicle).

For example, FIG. 6 includes a table illustrating criteria that can be utilized for selection of an operational mode and activation of selected components in the selected operational mode based on a surplus status or a deficit status for each of of the electric drive units 116, the battery pack 124, and/or the vehicle cabin. In some examples, the various criteria show in FIG. 6 can be determined, identified, and/or detected by the computerized controller 144 and utilized to control operation of the system 100 via the computerized controller 144.

As discussed above, the controller 144 can be configured to receive temperature data and/or signals from the temperature sensors 146a, 146b respectively associated with and/or in communication with the battery pack 124 and the electric drive units 116 and/or other temperature sensors. For examepl, the controller 144 can be further configured receive temperature data and/or signals from a temperature sensor (e.g., a user-adjustable thermostat) associated with and/or in communication with the vehicle cabin. In some examples, the controller 144 can process the temperature readings to identify whether each of the electric drive units 116, the battery pack 124, and/or the vehicle cabin has a heat surplus status or a heat deficit status. In some examples, the heat surplus status is determined based on a temperature signal being above an upper threshold value for the respective component. In some examples, a heat deficit status is determined by a temperature being below a lower threshold value for the respective component. In some examples, the upper and lower threshold values may be selected and/or determined based on one or more other criteria, such as, for example, an environmental (ambient) temperature, or one or more component enthalpy states, such as those described in International Application No. PCT/US2023/080318, the contents of which is incorporated by reference herein in its entirety for all purposes.

As shown in FIG. 6, in a condition where each of the elective drive units 116 and the battery pack 124 have a surplus status, the system 100 can be operated in a “split mode” (for example, as shown in FIG. 4). If the cabin has a surplus status, the cabin can be cooled by the evaporator 140. If the cabin has a deficit status, the cabin can be heated by heat generated from the WCC 128 and/or the electric drive units 116.

In a condition where the electric drive units 116 have a surplus status and the battery 124 has a deficit status, the system can be operated in a “mixed mode” (for example, as shown in FIG. 3). If the cabin has a surplus status, the cabin can be cooled by the evaporator 140. In some examples, heat from the evaporator 140 can be transferred to the WCC 132 and used to warm the battery 124 (for example, augment heating of the battery 124 by the electric drive units 116). If the cabin has a deficit status, the cabin can be heated by the PCH 136. Alternatively, where the electric drive units 116 have a surplus status and the battery 124 and the cabin have a deficit status, the system 100 can be operated in the “blending mode” discussed above with respect to the additional exemplary operational states.

In a condition wherein the electric drive units 116 have a deficit status and the battery 124 has a surplus status, the system 100 can be operated in a “mixed mode” (for example, as shown in FIG. 3). If the cabin has a surplus status, the cabin can be cooled by the evaporator 140. If the cabin has a deficit status, the cabin can be heated by the PCH 136 and/or the WCC 128 (if active).

In a condition wherein the electric drive units 116 have a deficit status and the battery 124 has a deficit status, the system 100 can be operated in a “mixed mode” (for example, as shown in FIG. 3). If the cabin has a surplus status, the cabin can be cooled by the evaporator 140. In some examples, heat from the evaporator 140 can be transferred to the WCC 132 and used to warm the battery 124 and/or the electric drive units 116. If the cabin has a deficit status, the cabin can be heated by the PCH 136.

In a condition where the system 100 transitions from a “not-in-use” status (i.e., an “off” status) to an “on” status, the system 100 can be operated in a “pre-conditioning heating mode” (for example, as shown in FIG. 5). In this mode, the cabin can optionally be heated by the PCH 136.

In some examples, a method for operating the system 100 (for example, via the computerized controller 144) can include determining and/or identifying a heat status (e.g., a surplus status or a deficit status) of the electric drive units 116 and determining and/or identifying a heat status (e.g., a surplus status or a deficit status) of the battery pack 124.

The method can further include, based at least on a surplus status of the electric drive units 116 and a surplus status of the battery pack 124, operating the system 100 in a split mode (for example, as shown in FIG. 4).

The method can further include, based at least on a surplus status of the electric drive units 116 and a deficit status of the battery pack 124, operating the system 100 in a mixed mode (for example, as shown in FIG. 3).

The method can further include, based at least on a deficit status of the electric drive units 116 and a surplus status of the battery pack 124, operating the system 100 in a mixed mode (for example, as shown in FIG. 3).

The method can further include, based at least on a deficit status of the electric drive units 116 and a deficit status of the battery pack 124, operating the system 100 in a mixed mode (for example, as shown in FIG. 3).

The method can further include, based at least on an initiating operation status of the system 100, operating the system 100 in a preconditioning heating mode (for example, as shown in FIG. 5).

In some examples, the method further includes monitoring the system 100 and causing transition from a first one of the operational modes to a second, different one of the operational modes when a heat status of the one or more of the electric drive units 116 or the battery pack 124 changes.

In some examples, a method for operating the system 100 (for example, via the computerized controller 144) can include determining a selected one of a plurality of operational states for the electrical system based at least on a temperature of one or more components of the electrical system. In some examples, the method can further include controlling operation of a first pump and a second pump to control a position of a shuttle within a passive valve to direct flow of coolant through selected circuits within a fluid pathway network of the thermal regulation system.

In some examples, the first pump is fluidly coupled to a first portion of the fluid pathway network upstream of the passive valve and the second pump is fluidly coupled to a second portion of the fluid pathway network upstream of the passive valve, wherein a third portion of the fluid pathway network is downstream of the passive valve and in fluid communication with a first outlet of the passive valve.

In some examples, a fourth portion of the fluid pathway network is downstream of the passive valve and in fluid communication with a second outlet of the passive valve.

In some examples, the shuttle is a first position in a relaxed state.

In some examples, the controlling operation of the first pump and the second pump comprises operating the first pump while the second pump is in an inactive state and thereby causing the shuttle to remain in the first position and block the second outlet to direct flow of coolant from the first pump to the third portion of the fluid pathway network.

In some examples, the controlling operation of the first pump and the second pump comprises operating the second pump while the first pump is in an inactive state and thereby causing the shuttle to be displaced to a second position to direct flow of coolant from the second pump to the third portion of the fluid pathway network.

In some examples, the controlling operation of the first pump and the second pump comprises operating the first and second pumps such that a first pressure generated by the first pump is less than a second pressure generated by the second pump and thereby causing the shuttle to be displaced to a third position to direct flow of coolant from the second pump to the third portion of the fluid pathway network and flow of coolant from the first pump to the fourth portion of the fluid pathway network.

In some examples, the controlling operation of the first pump and the second pump comprises operating the first and second pumps such that a first pressure generated by the first pump is equal to a second pressure generated by the second pump and thereby causing the shuttle to be displaced to a fourth position to direct flow of coolant from the first pump and flow of coolant from the second pump to the third portion of the fluid pathway network.

It will be appreciated that the foregoing criteria for selection of an operational mode can be stored in the memory 148 as one or more look-up tables that can be accessed by the processor(s) of the controller 144 and/or the foregoing methods for operating the system 100 can be stored in the memory 148 as one or more computer-readable instructions that can be executed by the processor(s) of the controller 144.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. A thermal regulation system comprising:
a passive valve comprising a shuttle disposed within a housing;
a first pump in fluid communication with the passive valve;
a second pump in fluid communication with the passive valve; and
a first fluid pathway in fluid communication with a first opening in the passive valve;
wherein a position of the shuttle is controllable via controlling operation of each of the first and second pumps, wherein, based at least on the position of the shuttle, the shuttle directs flow of fluid from one or more of the first pump or the second pump through the passive valve to the first fluid pathway.

2. The thermal regulation system of claim 1, wherein the position of the shuttle is controllable via operation of one of the first pump or the second pump while the other of the first pump or the second pump is inactive.

3. The thermal regulation system of claim 1, wherein the position of the shuttle is controllable via controlling a ratio of a first pressure generated by the first pump to a second pressure generated by the second pump.

4. The thermal regulation system of claim 1, wherein the shuttle is moveable between a plurality of positions via controlling operation of each of the first and second pumps, wherein the plurality of positions comprise a first position that causes the passive valve to direct fluid from the first pump to the first fluid pathway, a second position that causes the passive valve to direct fluid from the second pump to the first fluid pathway, and a third position that causes the passive valve to direct fluid from the first pump and fluid from the second pump to the first fluid pathway.

5. The thermal regulation system of claim 4, wherein the shuttle is biased toward an opening in the passive valve that is in communication with the second pump via a biasing structure, and wherein the shuttle is in the first position when the biasing structure is in a relaxed state.

6. The thermal regulation system of claim 5, wherein the biasing structure comprises a spring.

7. The thermal regulation system of claim 4, wherein the passive valve is configured such that operation of the second pump while the first pump is inactive results in displacement of the shuttle to the second position and flow of the fluid from the second pump through the first opening and into the first fluid pathway.

8. The thermal regulation system of claim 4, wherein the system is configured such that operation of the first and second pumps where a first pressure generated by the first pump is at a specified ratio with a second pressure generated by the second pump results in partial displacement of the shuttle to the third position and flow of the fluid from the first pump and flow of the fluid from the second pump through the first opening and into the first fluid pathway.

9. The thermal regulation system of claim 4, wherein the system is configured such that operation of the first and second pumps where a first pressure generated by the first pump is balanced with a second pressure generated by the second pump results in partial displacement of the shuttle to the third position and flow of the fluid from the first pump and flow of the fluid from the second pump through the first opening and into the first fluid pathway.

10. The thermal regulation system of claim 4, further comprising a second fluid pathway in fluid communication with a second opening in the passive valve, wherein the plurality of positions of the shuttle comprises a fourth position that causes the passive valve to direct fluid from the second pump to the first fluid pathway and fluid from the first pump to the second fluid pathway, wherein the system is configured such that operation of the first and second pumps where a first pressure generated by the first pump is at a specified ratio with a second pressure generated by the second pump results in displacement of the shuttle to the fourth position, flow of the fluid from the second pump through the first opening and into the first fluid pathway, and flow of the fluid from the first pump through the second opening and into the second fluid pathway.

11. A battery-powered electric vehicle comprising:
the thermal regulation system of claim 1;
a fluid pathway network, the fluid pathway network including the first fluid pathway;
an electric drive unit coupled to one or more wheels of the vehicle, wherein the first pump is upstream of the electric drive unit;
a battery pack, wherein the battery pack is communication with the first fluid pathway;
a chiller upstream of the battery pack, wherein the chiller is communication with the first fluid pathway; and
a coolant heater upstream of the second pump;
wherein the first pump is an electric drive unit pump for circulating coolant to one or more of the electric drive unit or the battery pack; and
wherein the second pump is a battery pump for circulating coolant to the battery pack.

12. A battery-powered electric vehicle comprising:
an electric drive unit coupled to one or more wheels of the vehicle;
a battery pack for powering the electric drive unit; and
a thermal regulation system for regulating one or more of an operating temperature of the electric drive unit or an operating temperature battery pack, wherein the thermal regulation system comprises:
a fluid pathway network;
a first pump fluidly coupled to a first portion of the fluid pathway network upstream of the electric drive unit;
a second pump fluidly coupled to a second portion of the fluid pathway network upstream of the battery pack;
a passive valve fluidly coupled to the fluid pathway network downstream of the first pump and the second pump, the passive valve comprising a shuttle that is moveable within a housing of the passive valve;
a temperature sensor in communication with the battery pack;
a computerized controller in signal communication with the temperature sensor and each of the first and second pumps and comprising one or more processors and a memory having computer-readable instructions stored thereon;
wherein the computer-readable instructions are configured to, when executed by the one or more processors, cause the computerized controller to, based at least on a detected temperature of the battery pack detected by the temperature sensor, control, via controlling operation of the first and second pumps, a position of the shuttle to direct coolant through the fluid pathway network over selected ones of one or more coolant loops.

13. The battery-powered electric vehicle of claim 12, wherein the temperature sensor is a first temperature sensor and the detected temperature is a first detected temperature, and wherein the thermal regulation system further comprising a second temperature sensor in communication with the electric drive unit, wherein the control of the position of the shuttle to direct coolant through the fluid pathway network over selected ones of one or more coolant loops is further based at least on a second detected temperature of the electric drive unit detected by the second temperature sensor control.

14. The battery-powered electric vehicle of claim 12, further comprising:
a chiller upstream of the battery pack, the chiller in fluid communication with the fluid pathway network; and
a coolant heater upstream of the second pump, the coolant heater in fluid communication with the fluid pathway network.

15. The battery-powered electric vehicle of claim 14, wherein the one or more coolant loops comprise a full vehicle loop, and wherein the thermal regulation system is configured such that operation of the first pump while the second pump is inactive results in activation of the full vehicle coolant loop to circulate coolant from the first pump to the electric drive unit through the passive valve to the chiller, the battery pack, and return to the first pump.

16. The battery-powered electric vehicle of claim 14, wherein the one or more coolant loops comprise a battery coolant loop, wherein the thermal regulation system is configured such that operation of the second pump while the first pump is inactive results in activation of the battery coolant loop to circulate coolant from the second pump through the passive valve to the chiller, the battery pack, the coolant heater, and return to the second pump.

17. The battery-powered electric vehicle of claim 14, wherein the one or more coolant loops comprise a battery coolant loop and an outer coolant loop, wherein the thermal regulation system is configured such that operation of the first and second pumps where a first pressure generated by the first pump is at a specified ratio relative to a second pressure generated by the second pump results in:
activation of the battery coolant loop to circulate a first portion of coolant from the second pump through the passive valve to the chiller, the battery pack, the coolant heater, and return to the second pump; and
activation of the outer coolant loop to circulate a second portion of coolant from the first pump to the electric drive unit and through the passive valve to one or more cabin temperature control components and return to the first pump.

18. The battery-powered electric vehicle of claim 14, wherein the passive valve is a first passive valve, and wherein the thermal regulation system further comprises a second passive valve disposed in the fluid pathway network downstream of the battery pack and upstream of the second pump, wherein second passive valve is configured to close during operation of the second pump.

19. The battery-powered electric vehicle of claim 18, wherein, in a closed state of the second passive valve, a battery coolant loop is closed to circulate coolant from the second pump through the first passive valve to the chiller, the battery pack, the coolant heater, and return to the second pump.

20. A battery-powered electric vehicle comprising:
an electric drive unit coupled to one or more wheels of the vehicle;
a battery pack for powering the electric drive unit; and
a thermal regulation system for regulating one or more of an operating temperature of the electric drive unit or an operating temperature battery pack, wherein the thermal regulation system comprises:
a fluid pathway network;
a first pump fluidly coupled to a first portion of the fluid pathway network upstream of the electric drive unit;
a second pump fluidly coupled to a second portion of the fluid pathway network upstream of the battery pack;
a first passive valve fluidly coupled to the fluid pathway network downstream of the first pump and the second pump, wherein the first passive valve is upstream of the battery pack and downstream of the electric drive unit, the first passive valve comprising a shuttle that is moveable within a housing of the first passive valve for directing flow of fluid through the first passive valve;
a second passive valve fluidly coupled to the fluid pathway network downstream of the battery pack and upstream of the second pump;
a first temperature sensor for detecting a temperature of the battery pack;
a second temperature sensor for detecting a temperature of the electric drive unit;
a computerized controller in signal communication with the first and second temperature sensors and each of the first and second pumps, the computerized controller comprising one or more processors and a memory having computer-readable instructions stored thereon;
wherein the computer-readable instructions are configured to, when executed by the one or more processors, cause the computerized controller to, based at least on one or more of the temperature of the battery pack detected by the first temperature sensor or the temperature of the of the electric drive unit detected by the second temperature sensor, control, via controlling operation of the first and second pumps, a position of the shuttle within the housing to direct coolant through the fluid pathway network over selected ones of a plurality of coolant loops.
